(19) United States
(12) Patent Application Publication
(10) Pub. No.: US 2023/0243914 A1
(43) Pub. Date: Aug. 3, 2023

(54) CONTROL DEVICE AND CONTROL METHOD

(71) Applicant: KABUSHIKI KAISHA TOKAI RIKA DENKI SEISAKUSHO, Aichi (JP)

(72) Inventors: Yoshiki OISHI, Aichi (JP); Kenichi KOGA, Aichi (JP); Tatsuya KOIKE, Aichi (JP); Satoshi MORI, Aichi (JP); Kento KATAOKA, Aichi (JP)

(73) Assignee: KABUSHIKI KAISHA TOKAI RIKA DENKI SEISAKUSHO, Aichi (JP)

(21) Appl. No.: 18/087,911

(22) Filed: Dec. 23, 2022

(30) Foreign Application Priority Data
Feb. 1, 2022 (JP) 2022-014204

(51) Int. Cl. G01S 5/02; G01S 5/04

(52) U.S. Cl. CPC G01S 5/0244; G01S 5/04

(57) ABSTRACT

A positional relationship between devices that have transmitted and received signals is more accurately estimated.

A control device comprising a control section configured to perform control of estimating a positional relationship between a communication device and another communication device based on a signal transmitted and received between the communication device including at least three or more antennas, and the another communication device including at least one or more antennas, wherein the control section performs the control of estimating the positional relationship by excluding a contradictory temporary result among temporary results of the positional relationship estimated based on the signal received by the communication device from the another communication device.

### CROSS REFERENCE TO RELATED APPLICATION(S)

This application is based upon and claims benefit of priority from Japanese Patent Application No. 2022-014204, filed on Feb. 1, 2022, the entire contents of which are incorporated herein by reference.

### BACKGROUND

The present invention relates to a control device and a control method.

In recent years, there is disclosed a technology that estimates a positional relationship between devices according to a result of transmission and reception of wireless signals between the devices. For example, WO 2015/176776 A discloses a technology that an Ultra Wide Band (UWB) receiver estimates an angle of incidence of a signal from a UWB transmitter by using a UWB signal.

### SUMMARY

However, according to the technology disclosed in above WO 2015/176776 A, it is likely that an error occurs in a reception phase of an antenna element when a position is estimated based on a phase difference between antenna elements, and therefore an error occurs in a position estimation result, too.

Therefore, the present invention has been made in light of the above problem, and an object of the present invention is to provide a new and improved control device and control method that can more accurately estimate a positional relationship between devices that have transmitted and received signals.

To solve the above described problem, according to an aspect of the present invention, there is provided a control device comprising a control section configured to perform control of estimating a positional relationship between a communication device and another communication device based on a signal transmitted and received between the communication device including at least three or more antennas, and the another communication device including at least one or more antennas, wherein the control section performs the control of estimating the positional relationship by excluding a contradictory temporary result among temporary results of the positional relationship estimated based on the signal received by the communication device from the another communication device.

To solve the above described problem, according to another aspect of the present invention, there is provided a control method executed by a computer, comprising performing control of estimating a positional relationship between a communication device and another communication device based on a signal transmitted and received between the communication device including at least three or more antennas, and the another communication device including at least one or more antennas, wherein performing the control of estimating the positional relationship includes performing the control of estimating the positional relationship by excluding a contradictory temporary result among temporary results of the positional relationship estimated based on the signal received by the communication device from the another communication device.

As described above, the present invention can more accurately estimate a positional relationship between devices that have transmitted and received signals.

### BRIEF DESCRIPTION OF THE DRAWINGS

FIG. 1 is a block diagram illustrating an example of a configuration of a system according to an embodiment of the present invention.

FIG. 2 is an explanatory view for explaining an outline example of the system according to the present embodiment.

FIG. 3 is a sequence diagram for explaining an example of a process of inter-device positional relationship estimation executed by the system according to the present embodiment.

FIG. 4 is an explanatory view for explaining a specific example of a process of signal arrival angle estimation.

FIG. 5 is an explanatory view for explaining an example of estimation of a positional relationship between a portable device and in-vehicle equipment when a phase error is not included.

FIG. 6 is an explanatory view for explaining an example of estimation of a positional relationship between the portable device and the in-vehicle equipment when a phase error is included.

FIG. 7 is a view for explaining an example of an operation process of positional relationship estimation by the system according to the present embodiment.

### DETAILED DESCRIPTION OF THE EMBODIMENT(S)

Hereinafter, referring to the appended drawings, a preferred embodiment of the present invention will be described below in detail. It should be noted that, in this description and the appended drawings, components that have substantially the same function and configuration are denoted with the same reference numerals, and repeated explanation thereof is omitted.

Furthermore, in this description and the appended drawings, elements that have substantially the same function and configuration are distinguished by adding different alphabets or numbers to tails of identical reference numerals in some cases. For example, a plurality of elements having substantially identical functions and configurations are distinguished like antennas 221A, 221B, and 221C as needed. In this regard, each of the plurality of elements are assigned only identical reference numerals in a case where each of the plurality of elements including the substantially identical functions and configurations do not particularly need to be distinguished. For example, the antennas 221A, 221B, and 221C are referred to simply as antennas 221 in a case where the antennas 221A, 221B, and 221C do not particularly need to be distinguished.

<<1. Configuration Example>>

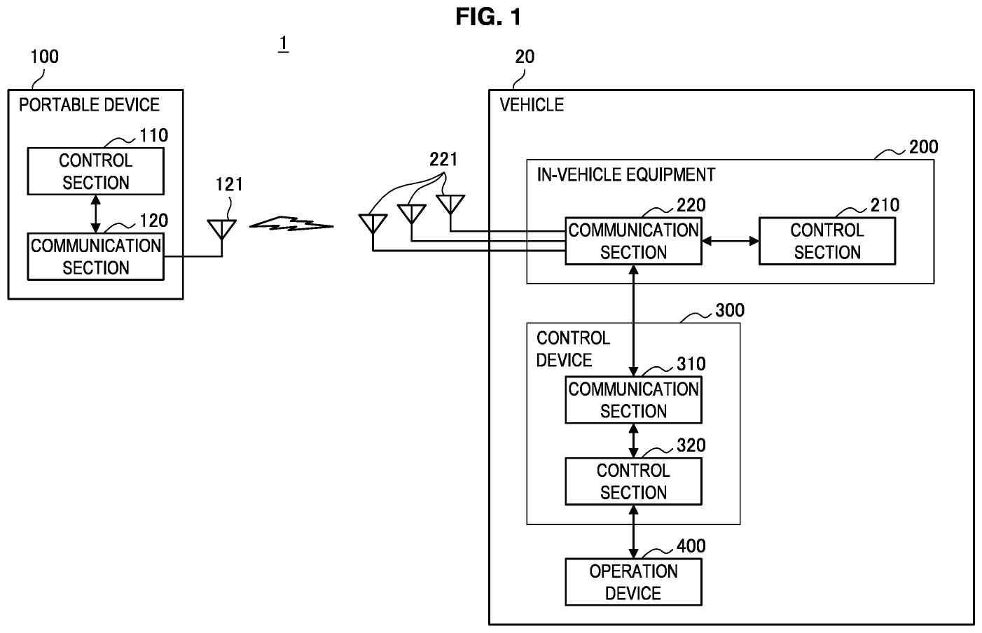

FIG. 1 is a block diagram illustrating an example of a configuration of a system 1 according to an embodiment of the present invention. As illustrated in FIG. 1, the system 1 according to the present embodiment includes a portable device 100, in-vehicle equipment 200, a control device 300, and an operation device 400.

The in-vehicle equipment 200, the control device 300, and the operation device 400 according to the present embodiment are mounted on, for example, a vehicle 20. The vehicle 20 is an example of a movable body, and is, for example, a vehicle (e.g., a vehicle owned by a user or a vehicle temporarily lent to the user) that the user is permitted to get on. Note that the movable body according to the present embodiment includes not only the vehicle 20, but also an airplane or a ship.

(Portable Device 100)

The portable device 100 is an example of another communication device, and is a device that is carried by the user who uses the vehicle 20. The portable device 100 may be an electronic key, a smartphone, a tablet terminal, a wearable terminal, and the like. As illustrated in FIG. 1, the portable device 100 includes a control section 110 and a communication section 120.

The control section 110 controls all operations of the portable device 100. The control section 110 causes the communication section 120 to transmit, for example, a Poll (Polling) signal described later. Furthermore, the control section 110 causes the communication section 120 to transmit a Final signal described later.

The control section 110 includes, for example, electronic circuits such as a Central Processing Unit (CPU) and a microprocessor.

The communication section 120 performs wireless communication with a communication section 220 included in the in-vehicle equipment 200. For example, the communication section 120 transmits the Poll signal according to control of the control section 110. Furthermore, the communication section 120 receives a Resp (Response) signal transmitted from the communication section 220 included in the in-vehicle equipment 200 as a response to the transmitted Poll signal. Furthermore, the communication section 120 transmits the Final signal as a response to the received Resp signal according to control of the control section 110.

Wireless communication between the communication section 120 and the communication section 220 included in the in-vehicle equipment 200 is expressed as, for example, a signal (expressed as a UWB signal below) that conforms to ultra wide band wireless communication. Using an impulse system for wireless communication that uses the UWB signal makes it possible to accurately measure an air propagation time of a radio wave by using a radio wave of a very short pulse width equal to or less than a nano second, and accurately perform positioning and distance measurement based on the propagation time. The communication section 120 is configured as a communication interface that can perform communication using, for example, a UWB signal.

Note that the UWB signal may be transmitted and received as a distance measurement signal and a data signal. The distance measurement signal is the Poll signal, the Resp signal, and the Final signal transmitted and received during a distance measurement process described later. The distance measurement signal may be configured in a frame format that does not include a payload part in which data is stored, or may be configured in a frame format that includes a payload part. On the other hand, the data signal is preferably configured in a frame format that includes a payload part in which data is stored.

Furthermore, wireless communication between the communication section 120 and the communication section 220 included in the in-vehicle equipment 200 is not limited to a UWB signal. For example, Blue Tooth (BT) communication and the like are applicable to the wireless communication between the communication section 120 and the communication section 220.

Furthermore, the communication section 120 includes at least one antenna 121. Furthermore, the communication section 120 transmits and receives a wireless signal via the at least one antenna 121.

(In-Vehicle Equipment 200)

The in-vehicle equipment 200 is an example of a communication device, and is a device that is mounted on the vehicle 20. As illustrated in FIG. 1, the in-vehicle equipment 200 includes a control section 210 and the communication section 220.

The control section 210 controls all operations of the in-vehicle equipment 200. The control section 210 causes the communication section 220 to transmit, for example, a Resp signal described later.

The control section 210 includes, for example, electronic circuits such as a CPU and a microprocessor.

The communication section 220 performs wireless communication with the communication section 120 included in the portable device 100. The communication section 220 receives a Poll signal transmitted from the communication section 120 included in the portable device 100. Furthermore, the communication section 220 transmits the Resp signal as a response to the received Poll signal according to control of the control section 210. Furthermore, the communication section 220 receives the Final signal transmitted from the communication section 120 included in the portable device 100 as a response to the transmitted Resp signal.

Furthermore, the communication section 220 includes the at least three or more antennas 221. Furthermore, the communication section 220 transmits and receives wireless signals via the three or more antennas 221. The following description will mainly describe an example where the number of the antennas 221 included in the communication section 220 is three.

(Control Device 300)

The control device 300 performs control of estimating a positional relationship between the portable device 100 and the in-vehicle equipment 200. As illustrated in FIG. 1, the control device 300 includes a communication section 310 and a control section 320.

Note that, although explanation on this description will describe an example where the vehicle 20 according to the present embodiment includes the in-vehicle equipment 200 and the control device 300 as separate components, the portable device 100 or the in-vehicle equipment 200 may realize functions of the control device 300.

The communication section 310 performs various types of communication with the in-vehicle equipment 200 by using an arbitrary communication system. For example, the communication section 310 receives information of signals transmitted and received between the portable device 100 and the in-vehicle equipment 200 from the communication section 220 included in the in-vehicle equipment 200. Note that the arbitrary communication system may be wired communication or may be wireless communication. Furthermore, the communication section 310 may perform various types of communication with the communication section 120 included in the portable device 100 by using a wireless communication system.

The control section 320 controls all operations of the control device 300. The control section 320 performs control of estimating a positional relationship between the portable device 100 and the in-vehicle equipment 200 based on, for example, the signals transmitted and received between the portable device 100 and the in-vehicle equipment 200.

For example, the control section 320 estimates a distance measurement value that is a distance between the portable device 100 and the in-vehicle equipment 200 based on the signals transmitted and received between the portable device 100 and the in-vehicle equipment 200.

Furthermore, the control section 320 estimates a signal arrival angle based on the signal received by the in-vehicle equipment 200 from the portable device 100. More specifically, the control section 320 estimates the signal arrival angle based on phase differences between antenna pairs of the three or more antennas included in the in-vehicle equipment 200.

Furthermore, the control section 320 may estimate a two-dimensional position or a three-dimensional position of the portable device 100 as the positional relationship between the portable device 100 and the in-vehicle equipment 200 based on the estimated distance measurement value and signal arrival angle.

For example, the control section 320 estimates a temporary result of the positional relationship between the portable device 100 and the in-vehicle equipment 200 per antenna pair based on the phase difference between each antenna pair of the three or more antennas included in the in-vehicle equipment 200.

Furthermore, the control section 320 performs control of estimating the positional relationship by excluding a contradictory temporary result among temporary results of the positional relationship between the portable device 100 and the in-vehicle equipment 200. The temporary results of the positional relationship between the portable device 100 and the in-vehicle equipment 200, and a specific example of contradiction of the temporary results will be described later.

The control section 320 includes, for example, electronic circuits such as a CPU and a microprocessor.

(Operation Device 400)

The operation device 400 is a device that operates according to control of the control device 300. The operation device 400 may be, for example, a key of doors included in the vehicle 20, or may be an engine included in the vehicle 20.

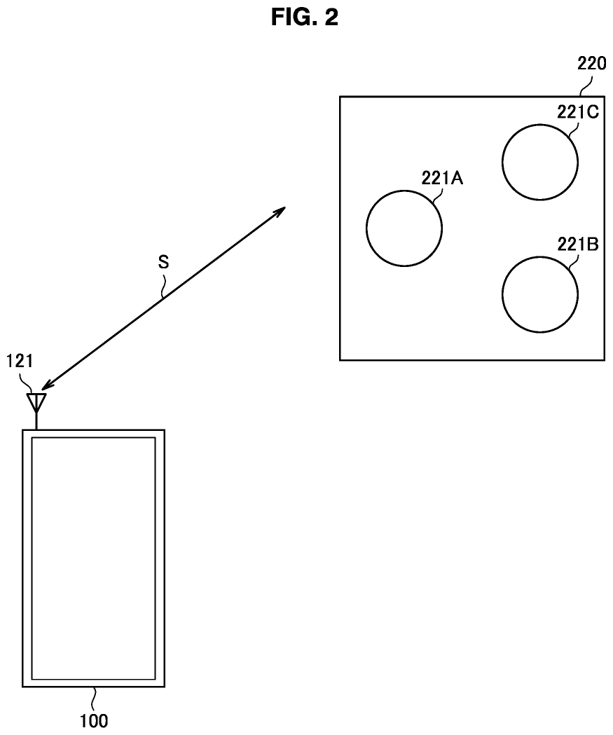

The configuration example of the system 1 according to the present embodiment has been described above. Next, technical features of the system 1 according to the present embodiment will be described with reference to FIGS. 2 to 6.

<<2. Technical Features>>

<2.1 Outline>

FIG. 2 is an explanatory view for explaining an outline example of the system 1 according to the present embodiment. The communication section 120 included in the portable device 100 includes the antenna 121 as illustrated in FIG. 2. Furthermore, the communication section 220 included in the in-vehicle equipment 200 includes, for example, the antenna 221A, the antenna 221B, and the antenna 221C as three element array antennas.

In this regard, the numbers of antennas included in the communication section 120 included in the portable device 100 and the communication section 220 included in the in-vehicle equipment 200 are not limited to these examples. For example, the number of the antennas 121 included in the communication section 120 may be plural, and the number of the antennas 221 included in the communication sections 220 may be four or more.

Furthermore, a scale ratio of the communication section 220 and the plurality of antennas 221 included in the communication section 220 is not limited to an illustrated scale ratio.

Furthermore, an arrangement shape of the three antennas is desirably arranged in, for example, an equilateral triangular shape illustrated in FIG. 2. In this regard, the arrangement shape of the three antennas is not limited to this example.

For example, the antenna 221A, the antenna 221B, and the antenna 221C may be arranged in an arbitrary arrangement shape as long as the antenna 221A, the antenna 221B, and the antenna 221C are respectively arranged at intervals equal to or less than a ½ wavelength. In this regard, the plurality of antennas 221 are desirably arranged on a plane instead of an identical straight line.

Furthermore, in FIG. 2, the antenna 121 included in the portable device 100 is arranged at a left end on an upper side of the portable device 100. However, a position at which the antenna 121 included in the portable device 100 is arranged is not limited to this example. For example, the antenna 121 may be arranged at an arbitrary position of the portable device 100.

As illustrated in FIG. 2, for example, the antenna 121 may transmit and receive a signal S to and from at least one or more antennas of the plurality of antennas 221 included in the communication section 220.

Furthermore, the communication section 310 included in the control device 300 receives information related to the signal S transmitted and received between the portable device 100 and the in-vehicle equipment 200 from one of the communication section 120 and the communication section 220.

Then, the control section 320 included in the control device 300 may estimate the positional relationship between the portable device 100 and the in-vehicle equipment 200 based on the transmitted and received signal S.

Next, a specific example of a process of estimating the positional relationship between the portable device 100 and the in-vehicle equipment 200 according to the present embodiment will be described.

<2.2. Positional Relationship Estimation>

(1) Distance Estimation

The control section 320 performs a distance measurement process. The distance measurement process is a process of estimating a distance between the portable device 100 and the in-vehicle equipment 200. The distance measurement process includes transmitting and receiving a distance measurement signal, and estimating a distance, i.e., a distance measurement value between the portable device 100 and the in-vehicle equipment 200 based on a time taken to transmit and receive the distance measurement signal.

According to the distance measurement process, a plurality of distance measurement signals can be transmitted and received between the portable device 100 and the in-vehicle equipment 200. A distance measurement signal transmitted from one device to an other device among the plurality of distance measurement signals will be referred to as a Poll signal.

Furthermore, a distance measurement signal transmitted from the device that has received the Poll signal as a response to the Poll signal to the device that has transmitted the Poll signal will be referred to as a Resp signal.

Furthermore, a distance measurement signal transmitted from the device that has received the Resp signal as a response to the Resp signal to the device that has transmitted the Resp signal will be referred to as a Final signal. Although the portable device 100 and the in-vehicle equipment 200 can transmit and receive any distance measurement signals, this description will describe an example where the portable device 100 transmits the Poll signal.

(2) Arrival Angle Estimation

The control section 320 estimates an arrival angle of a signal transmitted and received between the devices. This description will describe the Final signal included in the distance measurement signal as a signal for arrival angle estimation.

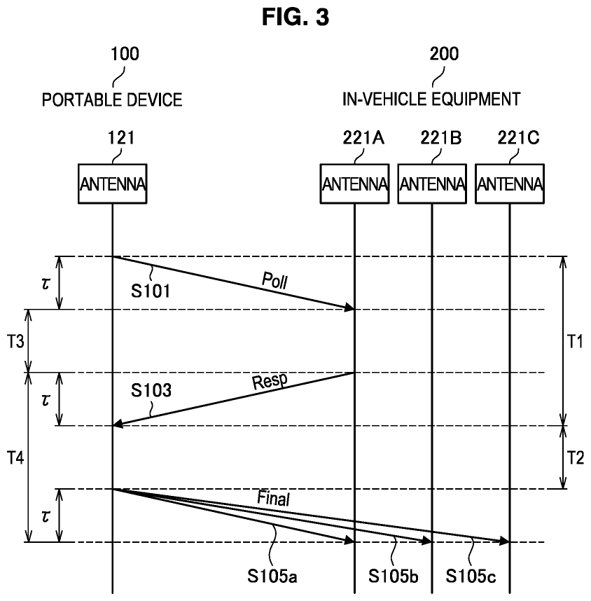

Hereinafter, an example of processes of distance estimation, arrival angle estimation, and temporary positional relationship estimation will be described with reference FIG. 3.

FIG. 3 is a sequence diagram for explaining an example of the process of inter-device positional relationship estimation executed by the system 1 according to the present embodiment.

First, the antenna 121 included in the portable device 100 transmits a Poll signal to the antenna 212A included in the in-vehicle equipment 200 (S101).

Next, the antenna 221A included in the in-vehicle equipment 200 transmits a Resp signal as a response to the Poll signal to the antenna 121 included in the portable device 100 (S103).

Furthermore, the antenna 121 included in the portable device 100 transmits a Final signal as a response to the Resp signal to the antenna 221A, the antenna 221B, and the antenna 221C included in the in-vehicle equipment 200 (S105).

In this regard, a time length taken by the portable device 100 to receive the Resp signal after transmitting the Poll signal is a time length T1, and a time length taken by the portable device 100 to transmit the Final signal after receiving the Resp signal is a time length T2. Furthermore, a time length taken by the in-vehicle equipment 200 to transmit the Resp signal after receiving the Poll signal is a time length T3, and a time length taken by the in-vehicle equipment 200 to receive the Final signal after transmitting the Resp signal is a time length T4.

The distance between the portable device 100 and the in-vehicle equipment 200 may be calculated by using each of the above-described time lengths. For example, the in-vehicle equipment 200 may receive a signal including information related to the time length T1 and the time length T2 from the portable device 100.

Next, the control device 300 may receive a signal including information related to the time length T1, the time length T2, the time length T3, and the time length T4 from the in-vehicle equipment 200.

Furthermore, the control section 320 calculates a signal propagation time τ by using the time length T1, the time length T2, the time length T3, and the time length T4. More specifically, the control section 320 may calculate the signal propagation time τ by using following equation 1.

τ=(T1×T4−T2×T3)/(T1+T2+T3+T4) (Equation 1)

Furthermore, the control section 320 may estimate the distance between the portable device 100 and the in-vehicle equipment 200 by multiplying the calculated signal propagation time τ with a known signal speed.

Note that an example where the control section 320 estimates the distance between the portable device 100 and the in-vehicle equipment 200 based on the signals transmitted and received between the antenna 121 included in the portable device 100 and the antenna 221A included in the in-vehicle equipment 200 has been described. However, the in-vehicle equipment 200 may transmit and receive the signals by using an antenna different from the antenna 221A, or may transmit and receive the signals by using the plurality of antennas 221.

Furthermore, the signal propagation time τ is not limited to a calculation method expressed by equation 1. For example, the signal propagation time τ can be calculated by subtracting the time length T3 from the time length T1, and dividing a resulting time by 2.

Next, a signal arrival angle may be calculated from phase differences between respective antenna pairs of the Final signals received by the plurality of antennas 221 included in the in-vehicle equipment 200.

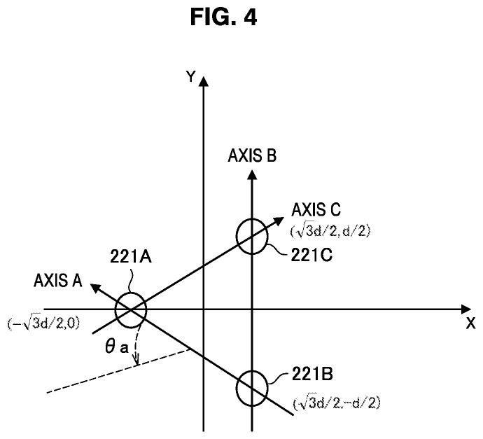

FIG. 4 is an explanatory view for explaining a specific example of a process of signal arrival angle estimation. For example, a phase of the Final signal received by the antenna 221A is a phase P_{A}, a phase of the Final signal received by the antenna 221B is a phase P_{B}, and a phase of the Final signal received by the antenna 221C is a phase P_{C}.

For example, a straight line that connects the antenna 221A and the antenna 221B is an axis A, a straight line that connects the antenna 221B and the antenna 221C is an axis B, and a straight line that connects the antenna 221A and the antenna 221C is an axis C.

Furthermore, a coordinate system in which a direction parallel to the axis B is a Y axis, and a direction perpendicular to the Y axis is an X axis is defined.

In a case of this coordinate system, phase differences Pd_{AB}, Pd_{CB}, and Pd_{CA} between antenna pairs are each expressed by using following equation 2.

Pd_{AB}=(P_{A}−P_{B})

Pd_{CB}=(P_{C}−P_{B})

Pd_{CA}=(P_{C}−P_{A}) (Equation 2)

In this regard, angles formed by the axis A, the axis B, and the axis C, and the signal are referred to as formed angles θ. In this regard, the formed angles θ are signal arrival angles, and are each expressed by equation 3. Note that λ represents a wavelength of a radio wave, and d represents a distance between the antennas.

θ=arccos(λ×Pd/(2πd)) (Equation 3)

Accordingly, the control section 320 calculates each of the signal arrival angles according to equation 4 based on equation 2 and equation 3. Note that θa represents the signal arrival angle with respect to the axis A, θb represents the signal arrival angle with respect to the axis B, and θc represents the signal arrival angle with respect to the axis C.

θa=θ_{AB}=arccos(λ×(P_{A}−P_{B})/(2πd))

θb=θ_{CB}=arccos(λ×(P_{C}−P_{B})/(2πd))

θc=θ_{CA}=arccos(λ×(P_{C}−P_{A})/(2πd)) (Equation 4)

Note that, when an error occurs in a phase in a case of d<(λ/2), (λ×Pd/(2πd)) in equation 3 is likely to deviate from a range of ±1, and it may become impossible to perform calculation.

Hence, assuming that, in a case of (λ×Pd/(2πd))>1, (λ×Pd/(2πd))=1 holds, and, in a case of (λ×Pd/(2πd))<−1, λ×Pd/(2πd))=−1 holds, the control section 320 may estimate the signal arrival angle.

Furthermore, the control section 320 may estimate a temporary positional relationship between the portable device 100 and the in-vehicle equipment 200 by using the estimated distance measurement value and the formed angle θ.

(3) Temporary Position Estimation

For example, the control section 320 may estimate a temporary positional relationship between the portable device 100 and the in-vehicle equipment 200 in the above-described coordinate system.

For example, the control section 320 estimates the temporary positional relationship between the portable device 100 and the in-vehicle equipment 200 by using a distance measurement value R and the signal arrival angle θ with respect to each axis of the axis A, the axis B, or the axis C. For example, the control section 320 may estimate an estimation value straight line that indicates a straight line including a position at which the portable device 100 exists as the temporary positional relationship between the portable device 100 and the in-vehicle equipment 200.

More specifically, the control section 320 estimates the estimation value straight line that is based on a phase difference between the antenna pair of the antenna 221A and the antenna 221B by using equation 5.

y=√3x−2R cos θa−(d/4) (Equation 5)

Furthermore, the control section 320 estimates the estimation value straight line that is based on a phase difference between the antenna pair of the antenna 221B and the antenna 221C by using equation 6.

y=R×cos θb (Equation 6)

Furthermore, the control section 320 estimates the estimation value straight line that is based on a phase difference between the antenna pair of the antenna 221A and the antenna 221C by using equation 7.

y=−√3x−2R cos θc+(d/4) (Equation 7)

Note that a term of (d/4) included in equation 5 and equation 7 is minor compared to a distance measurement error or the like in a case where the plurality of antennas 221 are arranged at the ½ wavelength or less, and therefore may be omitted.

Furthermore, the control section 320 estimates the positional relationship between the portable device 100 and the in-vehicle equipment 200 by excluding a contradictory temporary result among the temporary results of the estimation value straight lines of equation 5, equation 6, and equation 7.

<2.3. Final Decision>

Errors are likely to occur in the phases of the antennas 221 included in the in-vehicle equipment 200 due to various influences such as a disturbance. When such an error occurs, an error is likely to occur in an estimation result of the temporary positional relationship between the portable device 100 and the in-vehicle equipment 200 estimated by the control section 210.

When, for example, an error occurs in the phase of the certain antenna 221, there is a case where a phase difference between an antenna pair including this antenna 221 inverts. There is a case where an estimation value straight line estimated based on the phase difference between the antenna pair inverted in this way contradicts other estimation value straight lines.

Hence, the control section 320 according to the present embodiment estimates the positional relationship between the portable device 100 and the in-vehicle equipment 200 by excluding the contradictory temporary result among respective temporary results of a positional relationship estimated from phase differences between respective antenna pairs.

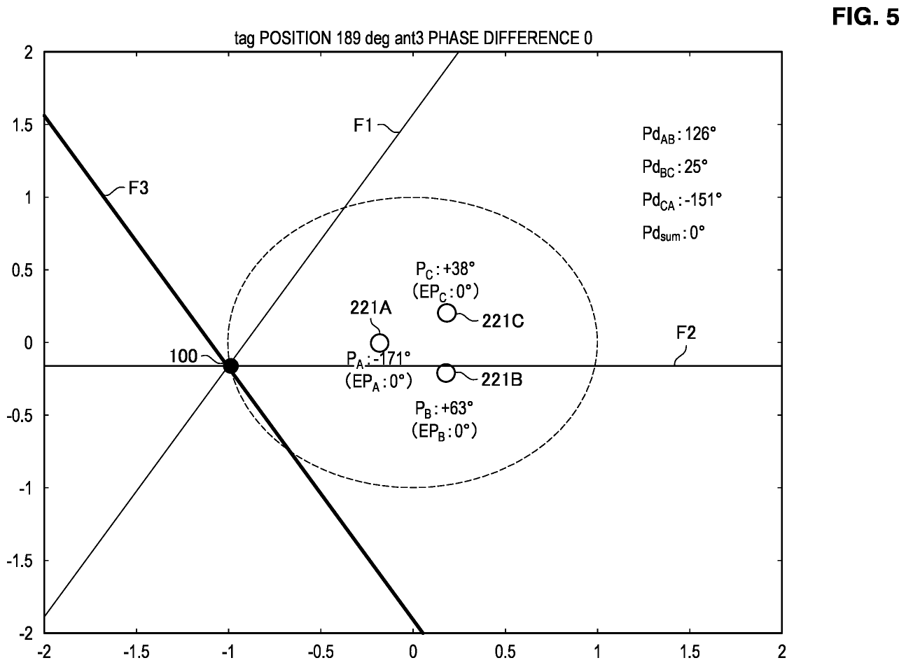

First, an example of positional relationship estimation in a case where an error does not occur in the phase of the antenna 221 will be described with reference to FIG. 5.

FIG. 5 is an explanatory view for explaining the example of estimation of the positional relationship between the portable device 100 and the in-vehicle equipment 200 in a case where a phase error is not included.

In the example illustrated in FIG. 5, the phase P_{A} of the antenna 221A is −171°, the phase P_{B} of the antenna 221B is +63°, and the phase P_{C} of the antenna 221C is +38.

Furthermore, in the example illustrated in FIG. 5, an error EP_{A} of the phase P_{A} of the antenna 221A, an error EP_{B} of the phase P_{B} of the antenna 221B, and an error EP_{C} of the phase P_{C} of the antenna 221C are each 0° (that is, an error does not occur).

Thus, when the phase of any one of the antenna 221A, the antenna 221B, and the antenna 221C does not include an error, the temporary results of the positional relationship based on the phase differences between the respective antenna pairs do not contradict.

An example of a method for deciding such contradiction of the temporary result includes a method that is based on a sum of the phase differences between the respective antenna pairs. For example, the control section 320 decides whether or not the temporary results of the positional relationship between the portable device 100 and the in-vehicle equipment 200 contradict based on the sum of the phase differences between the antenna pairs.

Furthermore, the control section 320 may perform control of estimating the positional relationship between the portable device 100 and the in-vehicle equipment 200 based on a result of the decision.

When, for example, a value obtained by adding a round of the phase differences between the respective antenna pairs of the antenna 221A, the antenna 221B, and the antenna 221C is near “0°”, the control section 320 may decide that the temporary results of the positional relationship between the portable device 100 and the in-vehicle equipment 200 do not contradict.

In the following description, the value obtained by adding a round of the phase differences between the respective antenna pairs of the antenna 221A, the antenna 221B, and the antenna 221C such as the phase differences Pd_{AB}, Pd_{BC}, and Pd_{CA} (−Pd_{AC}) is expressed as a sum Pdₛᵤₘ of the phase differences. In this regard, an antenna or a direction that serves as a start point of the round is not limited.

Furthermore, the sum Pdₛᵤₘ of the phase differences represents the sum of the respective phase differences in a case where the phase difference between each antenna pair is expressed within a range of ±180°. Consequently, the control section 320 can decide whether or not the plus and the minus of the phase difference have inverted.

When, for example, the sum Pdₛᵤₘ of the phase difference Pd_{AB} between the antenna pair of the antenna 221A and the antenna 221B, the phase difference Pd_{BC} between the antenna pair of the antenna 221B and the antenna 221C, and the phase difference Pd_{CA} between the antenna pair of the antenna 221C and the antenna 221A is near “0°”, the control section 320 decides that the phase difference between any antenna pair does not invert. In this case, three temporary results estimated based on the phase differences between three antenna pairs do not contradict.

On the other hand, when the sum Pdₛᵤₘ of the phase differences including the phase difference Pd_{AB} between the antenna pair of the antenna 221A and the antenna 221B, the phase difference Pd_{BC} between the antenna pair of the antenna 221B and the antenna 221C, and the phase difference Pd_{CA} between the antenna pair of the antenna 221C and the antenna 221A is near “360°” or “−360°”, the control section 320 decides that the phase difference between one of the antenna pair has inverted. In this case, the three temporary results estimated based on the phase differences between the three antenna pairs contradict. A case where temporary results contradict will be described later.

For example, in the example illustrated in FIG. 5, the phase difference Pd_{AB} is −234°, and is “+126°” when expressed within a range of ±180°. Furthermore, the phase difference Pd_{BC} is “+25°”. Furthermore, the phase difference Pd_{CA} is “+209°”, and is “−151°” when expressed within the range of ±180°. In this case, the sum Pdₛᵤₘ of the phase differences between the respective antenna pairs is “0°”, and therefore the control section 320 may decide that the phase difference between any antenna pair does not invert.

Furthermore, the control section 320 decides that the three temporary positional relationships do not contradict, and estimate the positional relationship between the portable device 100 and the in-vehicle equipment 200 based on the three temporary positional relationships.

For example, the control section 320 may estimate intersections of an estimation value straight line F1 that is based on the phase difference Pd_{AB}, an estimation value straight line F2 that is based on the phase difference Pd_{BC}, and an estimation value straight line F3 that is based on the phase difference Pd_{CA} as a position of the portable device 100.

Thus, the control section 320 can more accurately estimate the position of the portable device 100 by using the estimation value straight lines F1 to F3 based on the phase differences between the three antenna pairs whose phase differences do not contradict.

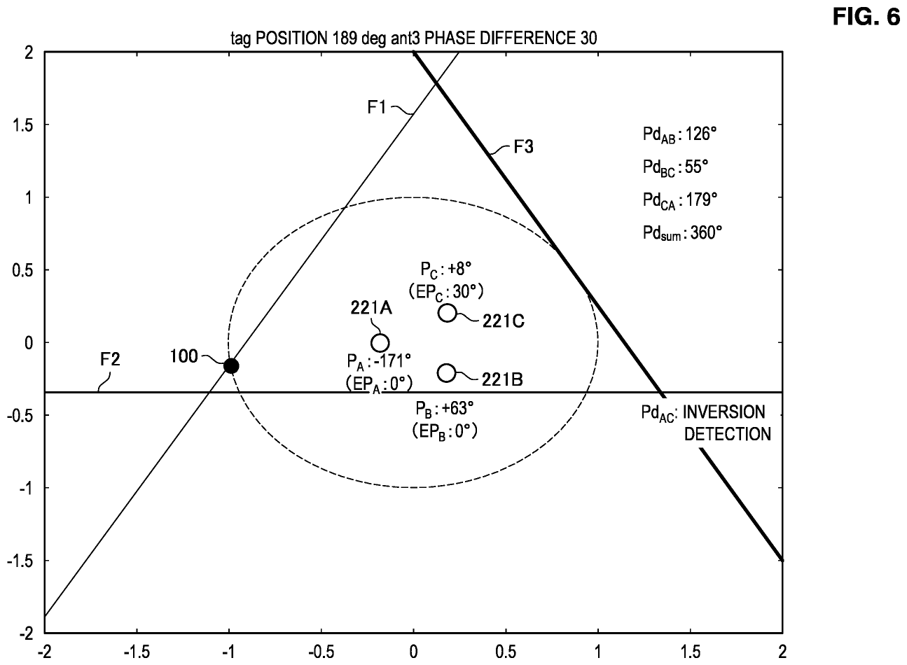

Next, an example of positional relationship estimation in a case where an error occurs in the phase of the antenna 221 will be described with reference to FIG. 6.

FIG. 6 is an explanatory view for explaining the example of estimation of the positional relationship between the portable device 100 and the in-vehicle equipment 200 when a phase error is included.

In the example illustrated in FIG. 6, the phase P_{A} of the antenna 221A is −171°, the phase P_{B} of the antenna 221B is 63°, and the phase P_{C} of the antenna 221C is 8°.

Furthermore, in the example illustrated in FIG. 6, an error EP_{A} of the phase P_{A} of the antenna 221A and an error EP_{B} of the phase P_{B} of the antenna 221B are each 0° (that is, an error does not occur), and an error EP_{C} of the phase P_{C} of the antenna 221C is 30°.

When an error occurs in the phase P_{C} of the antenna 221C, there is a case where, as illustrated in, for example, FIG. 6, the sum Pdₛᵤₘ of the phase differences between the respective antenna pairs indicates a value near “360°” or “−360°”. In this case, the control section 320 may decide that the phase difference between one of the antenna pairs has inverted.

For example, in the example illustrated in FIG. 6, the phase difference Pd_{AB} is −234°, and is “+126°” when expressed within the range of ±180°. Furthermore, the phase difference Pd_{BC} is “+25°”. Furthermore, the phase difference Pd_{CA} is “+179”. In this case, the sum Pdₛᵤₘ of the phase differences between the respective antenna pairs is “360°”, and therefore the control section 320 may decide that the phase difference between one of the antenna pairs has inverted.

For example, the control section 320 may decide that the phase difference between the antenna pair whose antenna pair phase difference is the closest to ±180° has inverted. In the example illustrated in FIG. 6, the control section 320 may decide that the phase difference that is the phase difference Pd_{CA} whose phase difference is the closest to ±180° has inverted.

Furthermore, the control section 320 may estimate the positional relationship between the portable device 100 and the in-vehicle equipment 200 by excluding as a contradictory temporary result the estimation value straight line F3 that is based on the phase difference Pd_{CA} for which it has been decided that the phase difference has inverted.

More specifically, the control section 320 may estimate as the position of the portable device 100 the intersection of the estimation value straight line F1 that is based on the phase difference Pd_{CA} for which it has been decided that the phase difference has not inverted and the estimation value straight line F2 that is based on the phase difference Pd_{CA}.

Furthermore, the control section 320 may estimate a z coordinate of the portable device 100 that is based on the two-dimensional position (xy coordinate positions) of the portable device 100 estimated according to the above-described method and the distance measurement value R by using equation 8.

z=±√(R²−x²−y²) (Equation 8)

Thus, by excluding a contradictory temporary result among the temporary results of the positional relationship between the portable device 100 and the in-vehicle equipment 200, the control section 320 can more accurately estimate the positional relationship between the portable device 100 and the in-vehicle equipment 200.

Note that the method for deciding whether or not temporary results contradict according to whether the sum of the phase differences between the antenna pairs is near “0°” or is near “±360°”. The word “near” described herein refers to, for example, predetermined ranges such as “0±5°” and “±360±10°”.

Furthermore, the method for deciding whether or not temporary results of a positional relationship contradict is not limited to this example. For example, the control section 320 may decide whether or not temporary results of a positional relationship contradict based on the respective intersections of the three estimation value straight lines F1 to F3.

For example, in the example illustrated in FIG. 6, the intersection of the estimation value straight line F1 and the estimation value straight line F2, the intersection of the estimation value straight line F2 and the estimation value straight line F3, and the intersection of the estimation value straight line F1 and the estimation value straight line F3 respectively indicate different positions. Hence, the control section 320 may decide that a temporary result of a positional relationship contradicts when the position indicated by each intersection is a predetermined value or more apart.

For example, in the example illustrated in FIG. 5, the intersection of the estimation value straight line F1 and the estimation value straight line F2, the intersection of the estimation value straight line F2 and the estimation value straight line F3, and the intersection of the estimation value straight line F1 and the estimation value straight line F3 respectively indicate identical or similar positions. In this case, the control section 320 may decide that temporary results of a positional relationship do not contradict.

Furthermore, when a size of a figure formed by connecting the respective intersections of the three estimation value straight lines F1 to F3 is a predetermined value or more, the control section 320 may decide that the temporary results of the positional relationship contradict. In this regard, an index that indicates the size of the figure may be, for example, a size of a circumscribed circle that corresponds to the figure, a sum of lengths of sides of straight lines that connect each intersection, and values that are indicated by various parameters such as an area of the figure, or may be a value that is calculated by combining various parameters.

Furthermore, the control section 320 may compare a size of a figure formed by connecting respective intersections of N estimation value straight lines, and a size of an inverted figure formed by connecting respective intersections in a case where one of the N estimation value straight lines is inverted, and decide that temporary positional relationships contradict when the inverted figure is smaller. Note that the estimation value straight line to be inverted among the N estimation value straight lines may be an estimation value straight line that is based on a phase difference between an antenna pair whose phase difference is the closest to ±180°.

For example, the control section 320 compares the size of the figure formed by connecting the respective intersections of the estimation value straight lines F1 to F3, and a size of an inverted figure formed by connecting respective intersections of the estimation value straight lines F1 and F2, and an estimation value straight line F3′ inverted from the estimation value straight line F3.

Furthermore, when the size of the inverted figure is smaller than the size of the figure formed by connecting the respective intersections of the estimation value straight lines F1 to F3, the control section 320 may decide that the temporary positional relationships contradict.

In this regard, the estimation value straight line F3 is a straight line that is based on a signal arrival angle θ_{C} (see equation 4) estimated by using the phase difference Pd_{CA} between the antenna pair of the antenna 221A and the antenna 221C. Furthermore, the estimation value straight line F3′ is a straight line that is based on a signal arrival angle θ_{C}′ estimated by using a phase difference inverted from the phase difference Pd_{CA} between the antenna pair of the antenna 221A and the antenna 221C.

In this regard, when, for example, the phase P_{C} is larger than the phase P_{A} (P_{C}−P_{A}>0), the signal arrival angle θ_{C}′ is calculated according to equation 9.

θc′=θ_{AC}′=arccos(λ×(−π)(2πd)) (Equation 9)

In this regard, when, for example, the phase P_{C} is smaller than the phase P_{A} (P_{C}−P_{A}<0), the signal arrival angle θ_{C}′ is calculated according to equation 10.

θ_{C}′=θ_{AC}′=arccos(λ×(π)/(2πd)) (Equation 10)

Furthermore, when there is an intersection (x²+y²>>R²) that is in a part outside a circle whose radius is the distance measurement value R and is a specified value or more apart from the distance measurement value R among the intersection of the estimation value straight line F1 and the estimation value straight line F2, the intersection of the estimation value straight line F2 and the estimation value straight line F3, and the intersection of the estimation value straight line F1 and the estimation value straight line F3, the control section 320 may decide that contradiction occurs, and estimate a two-dimensional position or a three-dimensional position of the portable device 100 by excluding the corresponding intersection.

Furthermore, when deciding that the temporary results of the positional relationship contradict, the control section 320 may not estimate the positional relationship, and may cause the portable device 100 and the in-vehicle equipment 200 to transmit and receive distance measurement signals again. In this case, the control section 320 may cause the portable device 100 and the in-vehicle equipment 200 to repeatedly transmit and receive the distance measurement signals until deciding that the temporary results of the positional relationship do not contradict.

Furthermore, the control section 320 may estimate a temporary positional relationship from each of the distance measurement signals transmitted and received a plurality of times. Furthermore, the control section 320 may make final decision on the positional relationship between the portable device 100 and the in-vehicle equipment 200 by excluding a temporary result that has been decided as contradictory among the temporary results of the estimated positional relationship.

The control section 320 temporarily estimates a two-dimensional position (xy coordinate positions) or a three-dimensional position (xyz coordinate positions) of the portable device 100 from, for example, each of signals transmitted and received five times. In this regard, when, for example, it has been decided that second and third estimation values contradict, the control section 320 may estimate as a final position of the portable device 100 a statistical value such as a median value or an average value of (i.e., first, fourth, and fifth) estimation values that have been decided as non-contradictory.

Furthermore, the description has mainly described the estimation value straight lines as the temporary positional relationships. However, the temporary positional relationships according to the present embodiment are not limited to these examples. Referring to FIG. 4 as an example, the control section 320 first estimates the distance measurement value R and the signal arrival angles θa of the antenna 221A and the antenna 221B. In this regard, the distance measurement value R is indicated by a broken line illustrated in FIG. 4.

Next, the control section 320 generates a cone by rotating about the axis A the broken line that indicates the distance measurement value R. Furthermore, the control section 320 may estimate that the portable device 100 exists on a circumference of a bottom surface of the generated cone. That is, the control section 320 may estimate an estimation value circle that is the circle of the bottom surface of the generated cone as a temporary positional relationship between the portable device 100 and the in-vehicle equipment 200.

Note that the estimation value circle based on the phase difference between the antenna pair of the antenna 221A and the antenna 221B is expressed by the above-described (equation 5) equation of the straight line on an XY plane illustrated in FIG. 4.

Hence, the control section 320 estimates three or more estimation value circles based on phase differences between respective antenna pairs and the distance measurement value R, and estimate an intersection of the estimation value circles that have been decided as non-contradictory based on a sum of the phase differences between the respective phase differences as a two-dimensional position or a three-dimensional position of the portable device 100.

The technical details according to the present embodiment have been described above. Next, an operation process example of the control device 300 according to the present embodiment will be described.

<<3. Operation Process Example>>

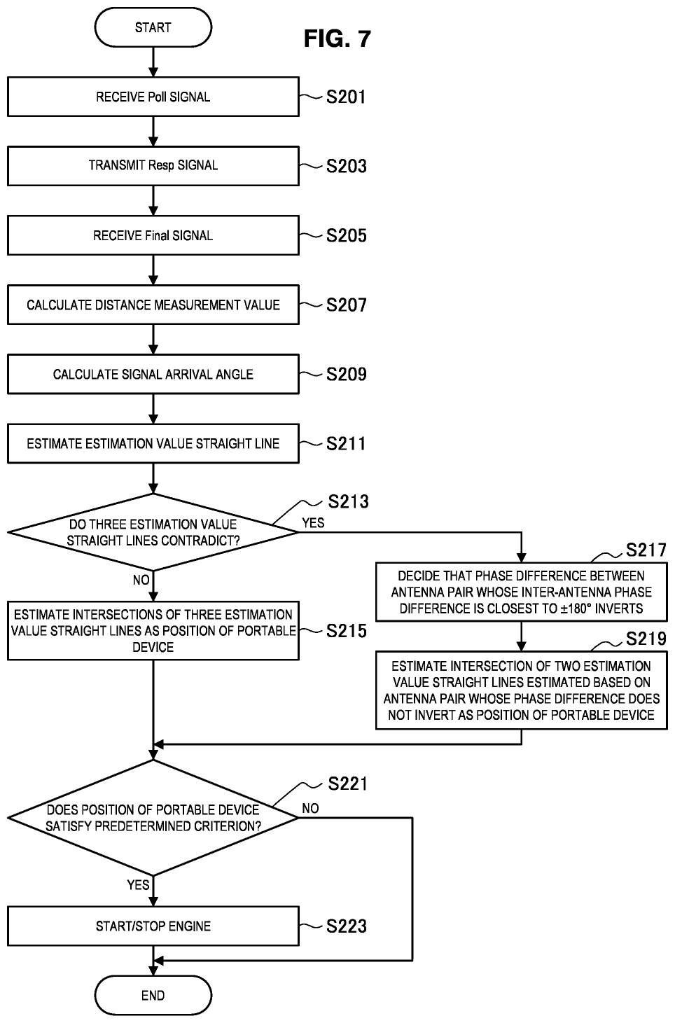

FIG. 7 is a view for explaining the example of an operation process of positional relationship estimation of the system 1 according to the present embodiment. First, the communication section 120 included in the portable device 100 transmits a Poll signal, and the communication section 220 included in the in-vehicle equipment 200 receives the Poll signal (S201).

Next, the communication section 220 transmits a Resp signal as a response to the Poll signal, and the communication section 120 receives the Resp signal (S203).

Furthermore, the communication section 120 transmits a Final signal as a response to the Resp signal, and the communication section 220 receives the Final signal (S205). In this regard, the communication section 220 transmits various pieces of information related to the signals transmitted and received to and from the communication section 120, to the communication section 310 included in the control device 300.

Next, the control section 320 calculates a distance measurement value based on the signals transmitted and received between the portable device 100 and the in-vehicle equipment 200 (S207).

Next, the control section 320 estimates an arrival angle of the signal received from the portable device 100 based on phase differences between antenna pairs (S209).

Furthermore, the control section 320 estimates an estimation value straight line based on the signal arrival angle estimated per antenna pair (S211).

Furthermore, the control section 320 decides whether or not the three estimation value straight lines contradict (S213). In a case where it is decided that contradiction does not occur (S213/No), the process proceeds to S215, and, in a case where it is decided that contradiction occurs (S213/Yes), the process proceeds to S217.

In a case where it is decided that the contradiction does not occur (S213/No), the control section 320 estimates the intersections of the three estimation value straight lines as the position of the portable device 100 (S215).

In a case where it is decided that the contradiction occurs (S213/Yes), the control section 320 estimates that the phase difference between the antenna pair whose inter-antenna phase difference is the closest to ±180° has inverted (S217).

Furthermore, the control section 320 estimates the intersection of the two estimation value straight lines estimated based on the phase difference between the antenna pair whose phase difference does not invert as the position of the portable device 100 (S219).

Furthermore, the control section 320 decides whether or not the position of the portable device 100 calculated by the control section 320 satisfies a predetermined criterion (S221). In a case where the predetermined criterion is satisfied (S221/Yes), the control section 320 moves the process to S223, and, in a case where the predetermined criterion is not satisfied (S221/No), the control section 320 ends the process.

In the case where the predetermined criterion is satisfied (S221/Yes), the control section 320 performs operation control of starting or stopping an engine that is an example of the operation device 400 (S223), and the control section 320 ends the process.

According to control of the control section 320 according to the above-described present embodiment, it is possible to reduce an influence of an error of a phase that may occur in an antenna, and more accurately estimate a positional relationship between the portable device 100 and the in-vehicle equipment 200.

<<4. Supplementary Explanation>>

Heretofore, the preferred embodiment of the present invention has been described in detail with reference to the appended drawings. However, the present invention is not limited to this embodiment. It should be understood by those who have common knowledge in the technical field to which the present invention belongs that it is obvious that various change examples or alteration examples can be arrived at within the scope of the technical idea recited in the claims, and these change examples and alteration examples also naturally belong to the technical scope of the present invention.

Furthermore, a series of processes of each device described in this description may be realized by using one of software, hardware, and a combination of the software and the hardware. Programs that configure the software are stored in advance in, for example, recording media (non-transitory media) provided inside or outside each device. Furthermore, each program is read on a RAM when, for example, executed by a computer, and is executed by a processor such as a CPU. The above recording media are, for example, a magnetic disk, an optical disk, a magneto-optical disk, and a flash memory. Furthermore, the above computer programs may be distributed via, for example, a network without using the recording media.

Furthermore, the steps of the process of the operation of the system 1 according to the present embodiment do not necessarily need to be processed in chronological order in order described in the explanatory view. For example, each step of the process of the operation of the system 1 may be processed in order different from the order described in the explanatory view, or may be processed in parallel.

What is claimed is:

1. A control device comprising a control section configured to perform control of estimating a positional relationship between a communication device and another communication device based on a signal transmitted and received between the communication device including at least three or more antennas, and the another communication device including at least one or more antennas,
wherein the control section performs the control of estimating the positional relationship by excluding a contradictory temporary result among temporary results of the positional relationship estimated based on the signal received by the communication device from the another communication device.

2. The control device according to claim 1,
wherein the control section performs control of estimating the temporary results of the positional relationship based on phase differences between respective antenna pairs of the three or more antennas included in the communication device.

3. The control device according to claim 2,
wherein the control section performs the control of estimating the temporary results of the positional relationship based on an arrival angle of the signal estimated based on the phase differences between the respective antenna pairs.

4. The control device according to claim 3,
wherein the control section performs the control of estimating the temporary results of the positional relationship based on the phase differences between the respective antenna pairs or the arrival angle of the signal, and a distance between the communication device and the another communication device that is based on the signal.

5. The control device according to claim 4,
wherein the three or more antennas included in the communication device are arranged such that an interval between the respective antenna pairs is a ½ wavelength or less.

6. The control device according to claim 5,
wherein the control section performs control of deciding whether or not the temporary results of the positional relationship contradict based on a sum of the phase differences between the respective antenna pairs.

7. The control device according to claim 6,
wherein the sum of the phase differences between the respective antenna pairs includes a value obtained by adding a round of the phase differences between the respective antenna pairs of the three or more antennas

8. The control device according to claim 7,
wherein the sum of the phase differences between the antenna pairs includes a sum of respective phase differences expressed within a range of ±180.

9. The control device according to claim 6,
wherein the control section performs control of estimating an estimation value straight line as the temporary result of the positional relationship, the estimation value straight line indicating a straight line including a position at which the another communication device exists.

10. The control device according to claim 9,
wherein the control section performs control of deciding that the estimation value straight line estimated per phase difference between each of the respective antenna pairs does not contradict when the sum of the phase differences between the respective antenna pairs of the three or more antennas included in the communication device is near 0°, and estimating the positional relationship based on the estimation value straight line estimated per phase difference between each of the respective antenna pairs.

11. The control device according to claim 10,
wherein the control section performs control of deciding that the estimation value straight line estimated per phase difference between the respective antenna pairs contradicts when the sum of the phase differences between the respective antenna pairs of the three or more antennas included in the communication device is near ±360°, and estimating the positional relationship by excluding the contradictory estimation value straight line based on a result of the decision.

12. The control device according to claim 11,
wherein the control section performs control of estimating the positional relationship by excluding as the contradictory estimation value straight line an estimation value straight line that is based on a phase difference closest to ±180° among the phase differences between the respective antenna pairs.

13. The control device according to claim 12,
wherein the control section performs control of estimating a two-dimensional position or a three-dimensional position of the another communication device as the positional relationship.

14. The control device according to claim 13,
wherein the control section performs control of estimating as a position of the another communication device an intersection of at least two or more estimation value straight lines that have been decided as non-contradictory.

15. The control device according to claim 9,
wherein the control section performs control of deciding whether or not the temporary result contradicts based on the position of the another communication device indicated by intersections of the three or more estimation value straight lines.

16. The control device according to claim 13,
wherein the control section performs control of deciding whether or not the temporary result contradicts based on whether or not a size of a figure formed by connecting each intersection of the three or more estimation value straight lines is a predetermined value or more.

17. The control device according to claim 15,
wherein the control section performs control of comparing a size of a figure formed by connecting respective intersections of a plurality of estimation value straight lines, and a size of a figure formed by inverting one estimation value straight line of the plurality of estimation value straight lines, and connecting respective intersections, and deciding whether or not the temporary result contradicts based on a result of the comparison.

18. The control device according to claim 9,
wherein the control section performs control of estimating the positional relationship by excluding an intersection of the three or more estimation value straight lines as the contradictory temporary result, the intersection being in a part outside a circle whose radius is the distance between the communication device and the another communication device based on the signal, and being a specified value or more apart from the circle.

19. The control device according to claim 6,
wherein the control section performs control of estimating an estimation value circle as the temporary result of the positional relationship, the estimation value circle indicating a circle that is a bottom surface of a cone based on the distance and the arrival angle of the signal, and includes the position at which the another communication device exists.

20. A control method executed by a computer, comprising performing control of estimating a positional relationship between a communication device and another communication device based on a signal transmitted and received between the communication device including at least three or more antennas, and the another communication device including at least one or more antennas,
wherein performing the control of estimating the positional relationship includes performing the control of estimating the positional relationship by excluding a contradictory temporary result among temporary results of the positional relationship estimated based on the signal received by the communication device from the another communication device.
